(19) United States
(12) Patent Application Publication
(10) Pub. No.: US 2007/0050460 A1
(43) Pub. Date: Mar. 1, 2007

(54) Document input and output device for identifying external devices and identifying processing method of document input and output device

(75) Inventor: Kiyoshi Kasatani, Kanagawa (JP)

Correspondence Address: HARNESS, DICKEY & PIERCE, P.L.C., P.O. BOX 8910, RESTON, VA, 20195, US

(73) Assignee: Ricoh Company, Ltd.

(21) Appl. No.: 11/509,746

(22) Filed: Aug. 25, 2006

(30) Foreign Application Priority Data
Aug. 31, 2005 (JP) 2005-251275

(51) Int. Cl. G06F 15/16

(52) U.S. Cl. 709/206

(57) ABSTRACT

A document input and output device for identifying external devices, the document input and output device being connected to a network and using a plurality of communication protocols, the document input and output device communicating documents in various data forms with plural information devices, includes a first identifying part configured to implement an identifying process wherein a function of a first information device can be used by identification of an individual; a second identifying part configured to implement an identifying process wherein a function of the document input and output device can be used by identification of an individual; a third identifying part configured to implement an identifying process wherein a function of a second information device can be used by identification of an individual; and an identification control part configured to control the first through third identifying parts.

### BACKGROUND OF THE INVENTION

1. Field of the Invention

The present invention relates to document input and output devices for identifying external devices and identifying processing methods of document input and output devices, and more particularly, a document input and output device for identifying external devices, the document input and output device being connected to a network and using plural communication protocols, the document input and output device communicating documents in various data forms to and from plural information devices, and identifying processing methods of a document input and output device.

2. Description of the Related Art

Recently and continuingly, a network communication system having a document input and output device for identifying external devices, the document input and output device being connected to a network and using plural communication protocols, the document input and output device communicating documents in various data forms to and from plural information devices, has been developed.

In such a network communication system, various application services wherein a document input and output device are used as a core are provided. For example, a document image read out or data made by an information device is sent to a designated address by e-mail, sent by a facsimile, or file-transferred to another information device. Information written in a received e-mail or an image in a file attached to the e-mail is recorded and output, sent to a designated facsimile, or file-transferred to the information device. Storing management of the data sent to the device is performed. See Japanese Laid-Open Patent Application Publication No. 2004-356822, for example.

However, in the document input and output device connected to such a network, it is necessary to connect to plural information devices via the network. Especially, if plural devices requiring identification are independently provided in the network, in a case of a device providing a function used only by a user identified and registered, it is necessary to input a user name and password to each of the devices. This is not easy for users to handle. In addition, while a single user name and password can be used if the system is unified, a large amount of money is necessary for developing a system for unifying management of identifying information already independently managed.

### SUMMARY OF THE INVENTION

Accordingly, embodiments of the present invention may provide a novel and useful document input and output device for identifying external devices and identifying processing method of a document input and output device.

More specifically, the embodiments of the present invention may provide a document input and output device for identifying external devices whereby, in a network communication system having a document input and output device providing a function used only by a user registered and identified by identifying action via an operation part and plural external devices connected to each other via the network and providing a function by identifying an individual via a protocol in the network, each of the devices is automatically identified by only a single identifying action via the operations part.

One aspect of the present invention may be to provide a document input and output device for identifying external devices, the document input and output device being connected to a network and using a plurality of communication protocols, the document input and output device communicating documents in various data forms with plural information devices, including: a first identifying part configured to implement an identifying process wherein a function of a first information device can be used by identification of an individual; a second identifying part configured to implement an identifying process wherein a function of the document input and output device can be used by identification of an individual; a third identifying part configured to implement an identifying process wherein a function of a second information device can be used by identification of an individual; and an identification control part configured to control the first through third identifying parts; wherein the identification control part combines the identifying processes of the first and second identifying parts so as to implement the identifying processes of the first and second identifying parts, and implements the identifying process of the third identifying part at the time when the function of the second information device is used.

It may be also the aspect of the present invention to provide a document input and output device for identifying external devices, the document input and output device being connected to a network and using a plurality of communication protocols, the document input and output device communicating documents in various data forms with a plurality of information devices, including: first means for implementing an identifying process wherein a function of a first information device can be used by identification of an individual; second means for implementing an identifying process wherein a function of the document input and output device can be used by identification of an individual; third means for implementing an identifying process wherein a function of a second information device can be used by identification of an individual; and means for controlling the first through third means; wherein the means for controlling the first through third means combines the identifying processes of the first and second means so as to implement the identifying processes of the first and second means, and implements the identifying process of the third means at the time when the function of the second information device is used.

It may be also the aspect of the present invention to provide an identifying processing method of a document input and output device, including: a first step of implementing an identifying process wherein a function of a first information device can be used by identification of an individual; a second step of implementing an identifying process wherein a function of the document input and output device can be used by identification of an individual; and a third step of implementing an identifying process wherein a function of a second information device can be used by identification of an individual; wherein the identifying processes of the first and second steps are implemented by combining the identifying processes of the first and second steps; and the identifying process of the third step is implemented at the time when the function of the second information device is used.

According to the above-mentioned invention, identification is made based on identifying information of the first information device among plural information devices connected to the network. The user completing this identification is identified as a registered user for using a function of the document input and output device. The registration and deletion of the registered user can be automatically managed.

Other objects, features, and advantages of the present invention will become more apparent from the following detailed description when read in conjunction with the accompanying drawings.

### BRIEF DESCRIPTION OF THE DRAWINGS

FIG. 1 is a system structural view including a digital color multifunction processing machine of an embodiment of the present invention;

FIG. 2 is a schematic perspective view of the digital color multifunction processing machine;

FIG. 3 is a block diagram showing electric connections of parts of the digital color multifunction processing machine;

FIG. 4 is a plan view showing a structure of an operations panel;

FIG. 5 is a block diagram showing a functional structure for controlling identifying action in the embodiment of the present invention;

FIG. 6 is a flowchart showing an operation of identifying action of an individual menu device of the digital color multifunction processing machine of the embodiment of the present invention;

FIG. 7 is a view showing a management setting table of setting information for a manager;

FIG. 8 is a view showing an individual setting table of individual setting information;

FIG. 9 is a flowchart showing an operation of identifying action of a first external device and the individual menu device in the digital color multifunction processing machine of the embodiment of the present invention;

FIG. 10 is a flowchart showing an operation of identifying action of a second external device after the first external device and the individual menu device are identified, of the embodiment of the present invention; and

FIG. 11 is a flowchart showing an operation of another identifying action of the first external device and the individual menu device in the digital color multifunction processing machine of the embodiment of the present invention.

### DETAILED DESCRIPTION OF THE PREFERED EMBODIMENTS

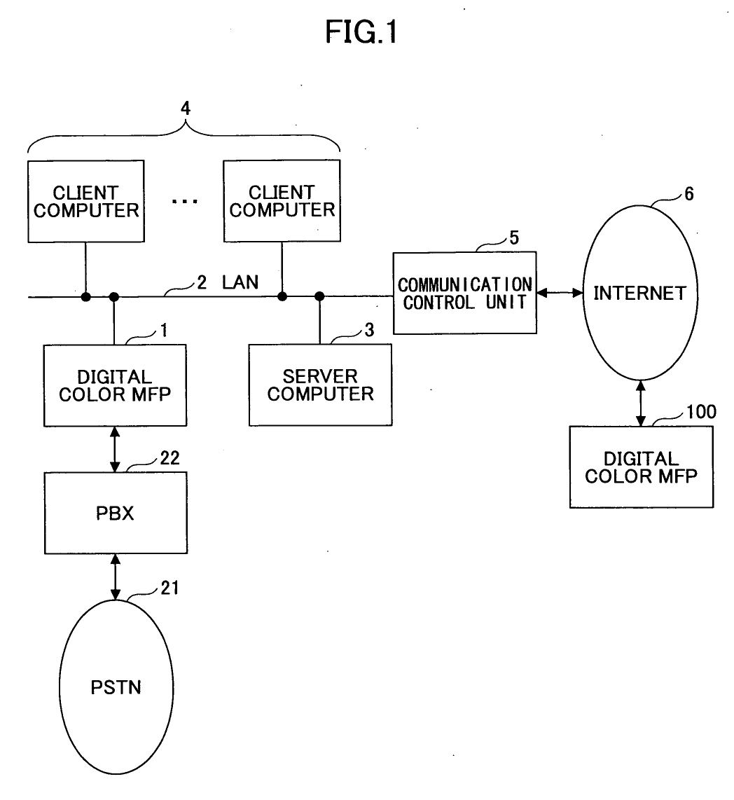

A description of the present invention is now given, with reference to FIG. 1 through FIG. 11, including embodiments of the present invention.

The following embodiment of the present invention is an example where the present invention is applied to so-called digital color multifunction processing machine where a copying function, facsimile function, printing function, scanner function, function for providing an input image (a document image read out by the scanner function or an image input by the printing function or the facsimile function), and others, are combined.

FIG. 1 is a system structural view including a digital color multifunction processing machine of an embodiment of the present invention.

As shown in FIG. 1, in the embodiment of the present invention, a system having the following structure is assumed. A server computer 3 and plural client computers 4 are connected to a digital color multifunction processing machine 1 that is an information processing system via a LAN (Local Area Network) 2 that is a communication network.

The server computer 3 implements various kinds of information processes. For example, the server computer 3 supports FTP or HTTP protocol or realizes a function of a Web server or DNS server (Domain Name Server).

In other words, in this system, an environment where an image processing function of the digital color multifunction processing machine 1 such as an image input function (scanner function), image output function (printing function), image storing function, and others, can be jointly shared on the LAN 2.

Such a system is connected to the Internet 6 via a communication control unit 5 so that data communication between this system and an external environment can be performed via the Internet 6. In addition a digital color multifunction processing machine 100 is provided on the Internet 6. The digital color multifunction processing machine 100 has the same function as the digital color multifunction processing machine 1.

While a router, exchange, modem, DSL modem, or the like is normal as the communication control unit 5, it should be capable of TCP/IP communications as a minimum. In addition, the LAN 2 is not limited to wire communications but may use wireless communication (infrared, electromagnetic wave, or the like). An optical fiber may be used for the LAN 2.

Next, details of the digital color multifunction processing machine 1 are discussed. The explanation of the digital color multifunction processing machine 1 is, of course, applied to the digital color multifunction processing machine 100.

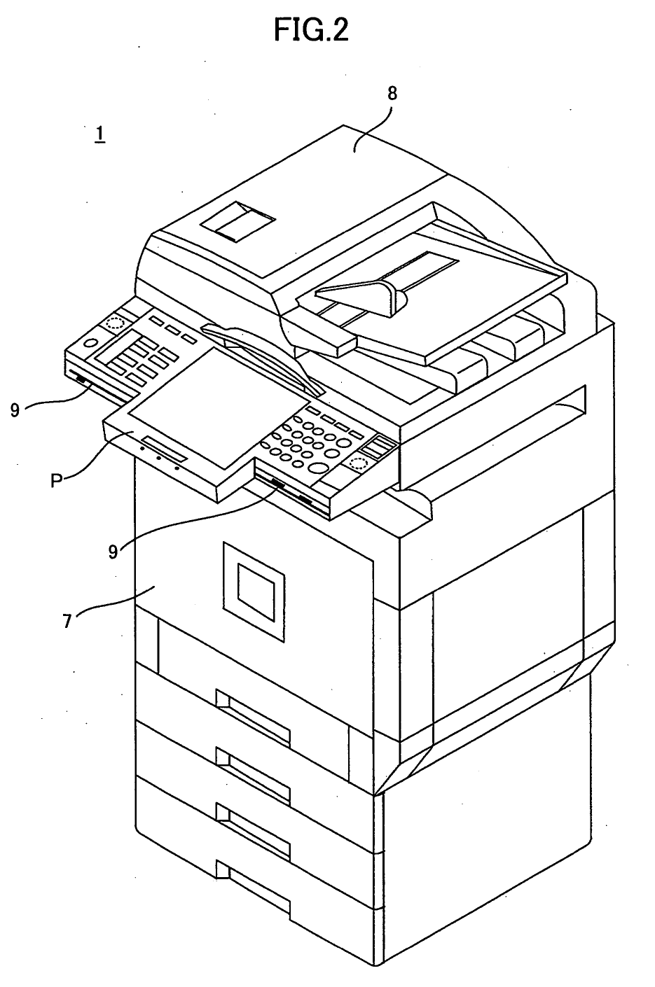

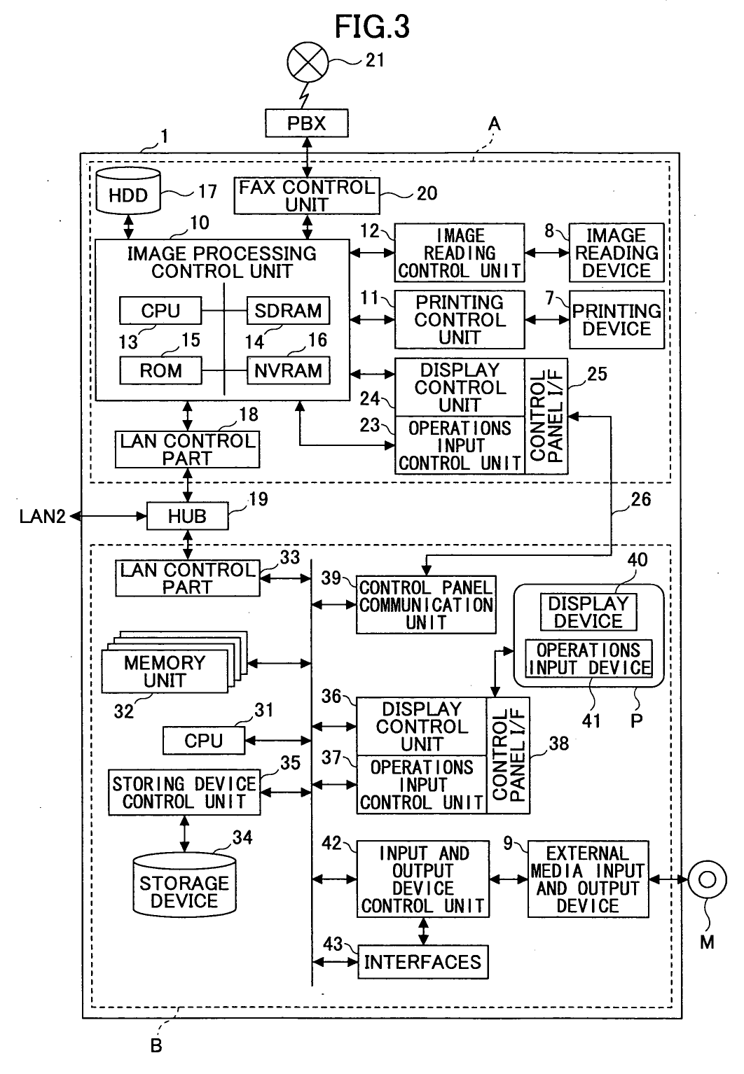

Here, FIG. 2 is a schematic perspective view of the digital color multifunction processing machine 1. FIG. 3 is a block diagram showing electric connections of parts of the digital color multifunction processing machine 1.

As shown in FIG. 2, in the digital color multifunction processing machine 1, an image reading device 8 is provided at an upper part of a printing device 7. The printing device 7 forms an image on a medium such as a transferring paper. The image reading device 8 reads out the image from a manuscript. An operations panel P is provided at an outside surface of the image reading device 8. The operations panel P displays for an operator and accepts various inputs such as function setting by the operator.

In addition, an external media input and output device 9 is provided at a lower part of the operations panel P so that an inserting opening for receiving a storage medium M (See FIG. 3) is exposed to the outside. The storage medium M is, for example, an optical disk or flexible disk. The external media input and output device 9 reads out program code, image data, or the like stored in the storage medium M and writes the program code, the image data, or the like to the storage medium M.

As shown in FIG. 3, the digital color multifunction processing machine 1 includes an image processing unit part A and an information processing unit part B. A printing device 7 and an image reading device 8 belong to the image processing unit part A. The operations panel P and the external media input and output device 9 belong to the information processing unit part B for performing various information processes.

First, the image processing unit part A is discussed. As shown in FIG. 3, the image processing unit part A having the printing device 7 and the image reading device 8 includes the image processing control unit 10. The image processing control unit 10 implements control of the entire imaging process at the image processing unit part A. A printing control unit 11 and an image reading control unit 12 are connected to the image processing control unit 10. The printing control unit 11 controls the printing device 7. The image reading control unit 12 controls the image reading device 8.

The printing control unit 11 outputs a printing order including the image data to the printing device 7 following the control of the image processing control unit 10. The printing control unit 11 makes the printing device 7 form the image on the transferring paper and output it. Full color printing can be performed by the printing device 7. As a printing method, not only an electrophotographic method but also various types of methods such as an inkjet type, a sublimation thermal transferring type, a silver photographing type, a direct thermal recoding type, or a melting thermal transferring type, can be used.

An image reading control unit 12 drives the image reading device 8 under the control of the image processing control unit 10. The image reading control unit 12 condenses a reflection light of lamp irradiation against the surface of a manuscript onto a light receiving element (for example, CCD (Charge Coupled Device)) by a mirror or lens so as to read it, and makes A/D conversion so as to generate digital image data of RGB 8 bits.

The image processing control unit 10 has a microcomputer structure where a CPU (Central Processing Unit) 13 being a main processor, an SDRAM (Synchronous Dynamic Random Access Memory) 14, a ROM (Read Only Memory) 15, and an NVRAM (Non Volatile RAM) 16 are connected by a bus. The image data read by the image reading device 8 is stored in the SDRAM 14 for a while for image forming by the printing device 7. A control program or the like is stored in the ROM 15. The NVRAM 16 can store the data even at the time of electric power loss when a system log, system setting or log information is recorded.

In addition, an HDD (magnetic disk device) 17, a LAN control part 18 and a FAX control unit 20 are connected to the image processing control unit 10. The HDD 17 is a storing device for storing a large amount of image data or job history. The LAN control part 18 connected the image processing unit part A to the LAN 2 via a HUB 19 that is a line concentrator of an internal LAN provided inside of the device. The FAX control unit 20 implements facsimile control. The FAX control unit 20 is connected to a PBX (Private Branch exchange) 22 connected to a public switched telephone network 21, so that the digital color multifunction processing machine 1 can make contact with a remote facsimile via the public switched telephone network 21.

In addition, a display control unit 23 and an operations input control unit 24 are connected to the image processing control unit 10.

The display part 23 outputs an image display control signal to the information processing unit part B via a communication cable connected to a control panel I/F (interface) 25 by control of the image processing control unit 10. The display part 23 implements control of the image display of the operations panel P of the information processing unit part B.

The operations input control unit 24 inputs an input control signal via the communication cable 26 connected to the control panel I/F 25 by the control of the image processing control unit 10. The input control signal corresponds to functional settings or input operations by the operator from the operations panel P of the information processing unit part B. In other words, the image processing unit part A directly monitors the operations panel P of the information processing unit part B via the communication cable 26.

Therefore, the image processing unit part A connects the communication cable 26 to an image processing unit which a conventional image processing device has so as to use the operations panel P of the information processing unit B. In other words, the operations input control unit 24 and the display control unit 23 of the image processing unit part A operate being connected to the operations panel P.

Under this structure, the image processing unit part A analyzes a printing order command and printing data that are image information from the outside such as the server computer 3, the client computer 4, the facsimile, or the like, so as to convert the printing data into bit-map data to be printed as the output image data. The image processing unit part A analyzes the printing data from the command and determines the operation. The image processing unit part A receives the printing data and the command from the LAN control part 18 or the FAX control unit 20 and operates on them.

In addition, the image processing unit part A can transfer the printing data, manuscript reading data, output image data made by processing these data for output, and compressed data made by compressing these data to the outside such as the server computer 3, the client computer 4, the facsimile, or the like.

Furthermore, the image processing unit part A transfers the reading data of the image reading device 8 to the image processing control unit 10, corrects signal degradation due to quantization of an optical system or a digital signal, and writes the image data in the SDRAM 14. Thus, the image data stored in the SDRAM 14 are converted to the output image data by the printing control unit 11 so as to be output to the printing device 7.

Next, the information processing unit part B having the operations panel P is discussed. As shown in FIG. 3, the information processing unit part B has a microcomputer structure where the information processing unit part B is controlled by a generic OS (Operating System) used for an information processing device generally called a personal computer. The information processing unit part B includes a CPU 31 as a main processor. A memory unit 32 and a storing device control unit 35 are connected by a bus to the CPU 31. The memory unit 32 includes a RAM that is a work area of the CPU 31 and a ROM that is exclusively a reading memory where a starting program is stored. The storing device control unit 35 controls input and output of the data to and from the storing device 34 such as an HDD storing a program or the OS.

A LAN control part 33 is connected to the CPU 31. The LAN control part 33 is a communication interface for connecting the information processing unit part B to the LAN 2 via the HUB 19. An IP address that is a network address allocated to the LAN control part 33 is different from the IP address allocated to the LAN control part 18 of the image processing unit part A. In other words, two IP addresses are allocated to the digital color multifunction processing machine 1 of the embodiment of the present invention. The image processing unit part A and the information processing unit part B are respectively connected to the LAN 2. Data conversion between the image processing unit part A and the information processing unit part B can be performed.

Since the digital color multifunction processing machine 1 is connected to the LAN 12 via the HUB 19, only a single IP address is seemingly allocated. Therefore, it is possible to easily handle connections without damaging a fine appearance.

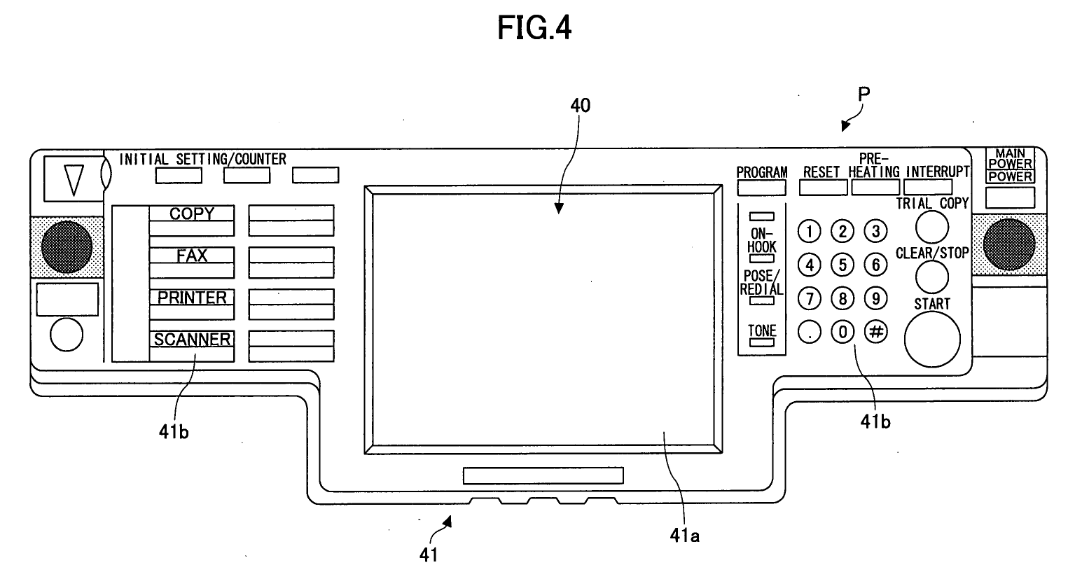

In addition, a display control unit 36 and an operations input control unit 37 for controlling the operations panel P are connected to the CPU 31. FIG. 4 is a plan view showing a structure of the operations panel P. As shown in FIG. 4, the operations panel P includes a display device 40 and an operations input device 41. The display device 40 is, for example, LCD (Liquid Crystal Display). The operations input device 41 includes a touch panel 41a and a key board 41b. The touch panel 41a is an ultrasonic elastic wave type panel stacked on a surface of the display device 40. The key board 41b has plural keys.

A start key, ten-key, reading condition setting key, clear key, and others are provided on the key board 41b. The start key is used for starting a process such as an image reading process. The ten key is used for input a numerical value. The reading condition setting key is used for setting the address to which the read image data are sent. In other words, the display control unit 36 outputs the image display control signal to the display device 40 via the control panel I/F 38 so as to make the display device 40 display a designated item corresponding to the image display control signal. On the other hand, the operations input control unit 37 receives an input control signal via the control panel I/F 38. This input control signal corresponds to functional settings or input operations by the operator in the operations input device 41.

In addition, a control panel communication unit 39 is connected to the CPU 31. The control panel communication unit 39 is connected to the control panel I/F 25 of the image processing unit part A via the communication cable 26.

The control panel communication unit 39 receives the image display control signal output from the image processing unit part A. The control panel communication unit 39 also transfers the input control signal corresponding to the functional setting or input operations from the operations panel P by the operator, to the image processing unit part A.

As discussed below, the image display control signal from the image processing unit part A received by the control panel communication unit 39 is processed for data conversion for the display device 40 of the operations panel P and then output to the display control unit 36.

In addition, the input control signal corresponding to the functional settings or input operations from the operations panel P by the operator is converted to a format corresponding to a specification of the image processing unit part A and then input to the control panel communication unit 39.

As discussed above, the OS or program implemented by the CPU 31 is stored in the storing device 34. This means that the storing device 34 functions as a storage medium storing the program.

In the digital color multifunction processing machine 1, if the user turns on the electric power, the CPU 31 activates a starting program in the memory unit 32 so that the OS is read from the storage device 34 and written by the RAM in the memory unit 32 so that this OS is activated. Such an OS activates a program corresponding to the operation of the user and reads and stores the information. For example, Windows (Registered Trademark) and others are each known as such an OS. An operating program used for the OS is called an application program. The same type of OS used for the information processing device such as the server computer 3 or the client computer 4, namely a generic OS such as Windows (Registered Trademark) is used as the OS of the information processing unit part B.

As discussed above, the external media input and output device 9 is provided in the digital color multifunction processing machine 1. The external media input and output device 9 is a device for reading the program code or the image data stored in a storage medium M or for storing the program code or the image data in the storage medium M, such as a flexible disk drive device, an optical disk drive device, an MO drive device, or a media drive device. The storing medium M is a medium where various program code sets (control programs) such as various application programs, the device driver, or the OS is stored. The storing medium M is, for example, a flexible disk, a hard disk, an optical disk (CD-ROM, CD-R, CD-RW, DVD-ROM, DVD-RAM, DVD-R, DVD+R, DVD-RW, DVD+RW, and others), or a semiconductor medium (SD memory card (registered trademark), Compact Flash (registered trademark), Memory Stick (registered trademark), Smart Media (registered trademark), or the like). Such an external media input and output device 9 is controlled by an input and output device control unit 42 that is connected by bus to the CPU 31.

Accordingly, the application program stored in the storage device M may be installed in the storage device 34. Because of this, the storage medium M can be the storage medium storing the application program. In addition, the application program may be taken in from the outside via, for example, the Internet or LAN 2 so as to be installed in the storage device 34.

Various interfaces 43 such as USB, IEEE 1394, and SCSI are connected to the input and output device control unit 42. Hence, via the various interfaces 43, various devices such as a digital camera can be connected to the input and output device control unit 42.

Next, a specific process implemented by the digital color multifunction processing machine 1 is discussed. In the digital color multifunction processing machine 1, plural devices implementing different processes from each other, namely the image processing unit part A and the information processing unit part B in this example, can independently perform the processes. Therefore, when the image reading process is implemented by the image processing unit part A, the information processing unit part B can receive e-mail, for example. In this example, since the results of the processes do not affect each other, there is no problem in independent operations of the image processing unit part A and the information processing unit part B.

Furthermore, in the digital color multifunction processing machine 1, each of the functions of the image processing unit part A can be used by the program operated by the information processing unit part B and the result can be a subject of the processing. For example, image data of a document image read by the image reading device 8 of the image processing unit part A is character-recognition processed by a designated application program so that a text document can be obtained.

However, if the image processing unit part A and the information processing unit part B always perform the processes independently from each other, each of the functions of the image processing unit part A cannot be used by the program operated by the information processing unit part B and the result cannot be the subject of the processing. Because of this, in this example, each of the functions of the image processing unit part A cannot be used by operating the application program based on the combination of process modules.

In the image processing unit part A, a module of a control system executed by the image processing control unit 10 is formed by an application program for implementing original functions of a multifunction processing machine by the digital color multifunction processing machine 1. In the digital color multifunction processing machine 1, an interface of a functional module for a network is provided at the LAN control part 18 to which access from only the information processing unit part B via the HUB 19 (LAN 2) can be made.

Based on the functional module for the network, a function provided for a normal multifunction processing machine as a standard and implemented by the image processing control unit 10, such as the scanner function or facsimile function, can be used via the LAN 2. The function cannot be used by the image processing unit part A.

When TCP/IP (Transmission Control Protocol/Internet Protocol) detects a connection requirement for a corresponding port number, a process module of a corresponding function is activated. Here, the TCP/IP always monitors access from the LAN 2.

For example, when the connection of the port number 1002 is requested, a module of a facsimile receiving function is activated. The activated module operates based on the processing requirement from a side requesting the connection so as to reply with a necessary response.

Next, a specific feature of an application program of the information processing unit part B is discussed. A key word generation application is discussed as an example.

The keyword generation application implements the character recognition process for the image data being read so that a keyword is made from the result of the character recognition. In the entirety of the information processing unit part B, each of the application programs is executed under the management of the OS.

In addition, each of the application programs can use the functions provided by the OS. In other word, while the application program is executing the OS is used as a module of the software so that a necessary process is performed. For example, the TCP/IP control module implements a function provided in the OS as a standard, the function being used for communication with other information devices connected by the TCP/IP.

Furthermore, an independent application program installed for use by other application programs can be used. For example, an OCR engine implements only a character recognition process from the image data. Since the OCR engine does not operate individually, the OCR engine is used as a part (module) of other application programs.

Thus, since each of the application programs can be executed under the management of the OS in the entirety of the information processing unit part B, an application program having these functions can be developed.

However, in the conventional technology, the functions of the image processing unit part A and others cannot be directly used by such means.

In other words, as discussed above, in the digital color multifunction processing machine 1, the image processing unit part A for implementing the original function of the multifunction processing machine and the information processing unit part B for implementing the application programs are provided. The image processing unit part A and the information processing unit part B are connected to each other via the LAN 2 by the network protocol (TCP/IP in this example) in the digital color multifunction processing machine 1.

Since the image processing unit part A and the information processing unit part B are physically connected, it is possible to mutually communicate data between the image processing unit part A and the information processing unit part B. However, in the conventional technology, the function of the image processing unit part A cannot be used from inside of the application program executing in the information processing unit part B.

Here, means for using the function of the image processing unit part A from inside of the application program executing in the information processing unit part B are discussed.

For example, in the keyword generation application, the image data are read from the image reading device 8 managed by the image processing unit part A.

In order to instruct the image reading device 8 to perform image reading operations, it is necessary to designate the port number 1001 and request a TCP/IP connection to the image processing unit part A. At this time, data indicating the contents of the process are simultaneously sent as a data stream.

In the function designated by the port number 1001, the image reading device 8 reads the image. An optional file name is added to the image data and the image data are transferred to the information processing unit part B. The contents of such a process are determined in advance. The port number is allocated so that these functions are individually used.

Thus, the functions of the image processing unit part A can be used from the keyword generation application. The communication protocol is not limited to TCP/IP but may be other types of protocols.

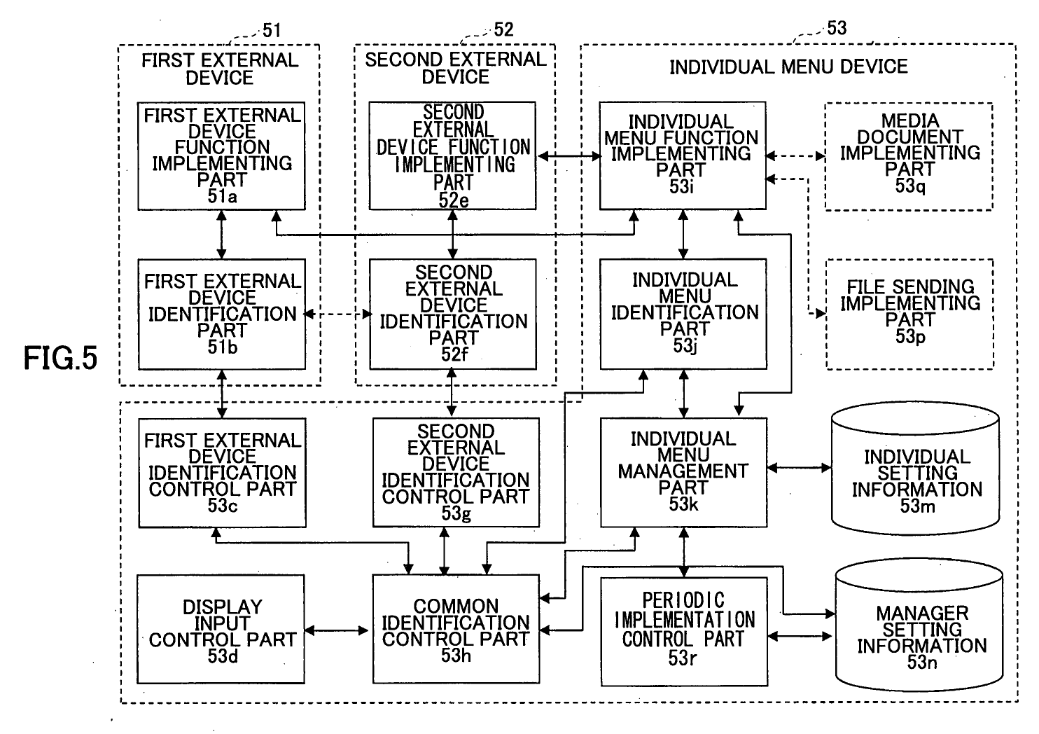

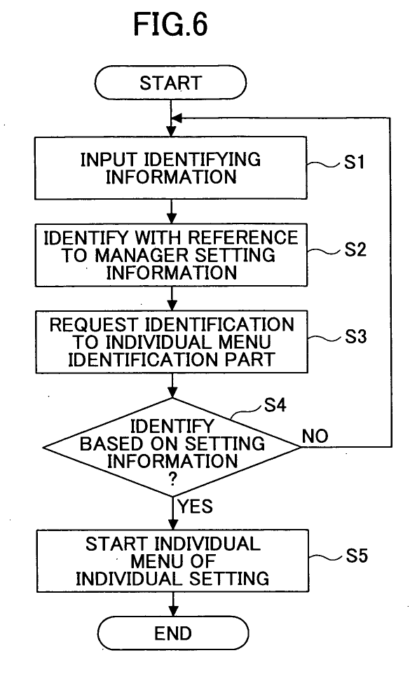

FIG. 5 is a block diagram showing a functional structure for controlling identifying action in the embodiment of the present invention. In FIG. 5, arrows connecting blocks represent main flows of signals. This does not limit the function of each of the blocks. In addition, in FIG. 5, a first external device 51 corresponds to the server computer 3 shown in FIG. 1. A second external device 52 corresponds to the image processing unit part A shown in FIG. 3. An individual menu device 53 corresponds to the information processing unit part B shown in FIG. 3. FIG. 6 is a flowchart showing an operation of identifying action of an individual menu device of the digital color multifunction processing machine of the embodiment of the present invention.

Based on the flowchart of FIG. 6, the operation in the embodiment of the present invention is discussed with reference to FIG. 5.

As an identifying action in the digital color multifunction processing machine 1 shown in FIG. 6, a display input control part 53d of the individual menu device 53 receives identifying information of the user (user name, password, ID card for identifying, and others) from the main picture displayed at the operations panel P (See FIG. 4), for example in step S1. The identifying information of the user is input from the input picture of the identifying information by pushing the individual identifying key.

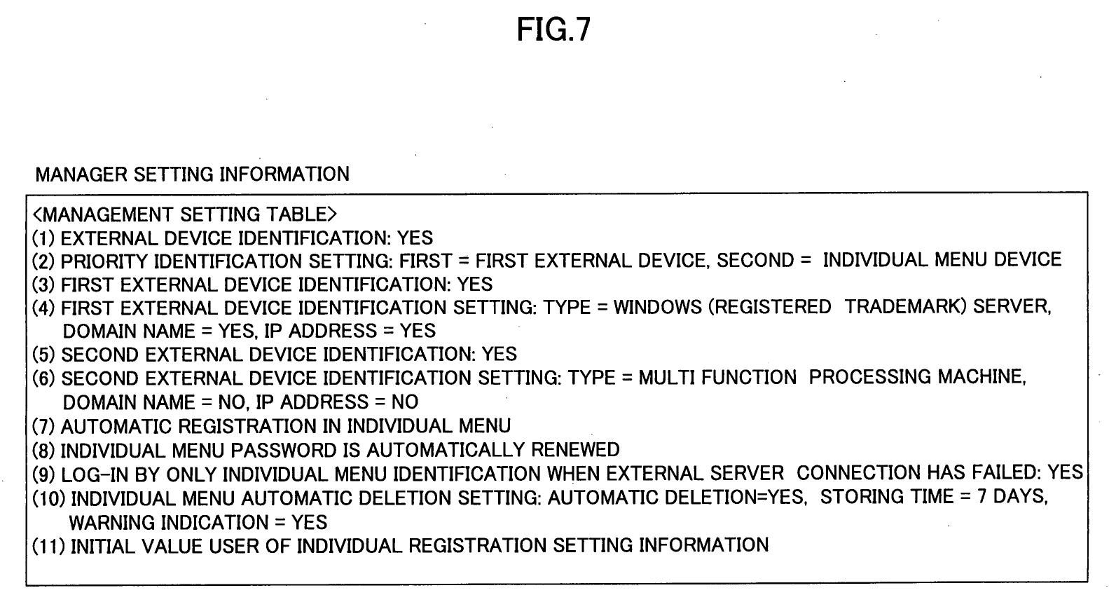

The display input control part 53d transfers the input identifying information to a common identification control part 53h. The common identification control part 53h identifies the information following the setting of a manager setting information 53n in step S2. Here, in setting the manager setting information 53n, in a case where the item (1) of a management setting table shown in FIG. 7 is “EXTERNAL DEVICE IDENTIFICATION: NO”, the common identification control part 53h requests identification of the individual menu from an individual menu identification part 53j in step S3.

An individual menu management part 53k determines whether corresponding information exists with reference to individual setting information 53m in step S4. If the identification is successful (YES of step S4), the individual menu identification part 53j requests an individual menu function implementing part 53i to start the individual menu.

The individual menu function implementing part 53i obtains individual settings of the individual setting information 53m via the individual menu management part 53k so as to start the individual menu in this individual setting in step S5. Thus, an identification flow to the individual menu device is implemented.

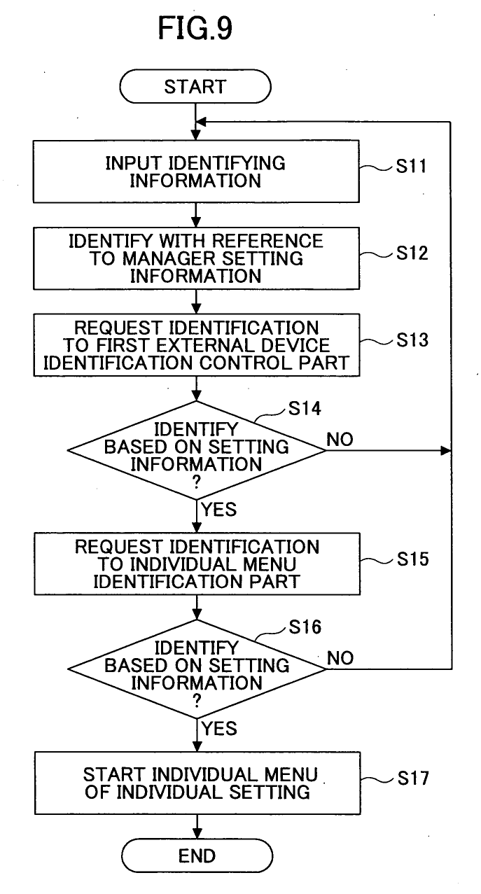

Meanwhile, FIG. 9 is a flowchart showing an operation of identifying action of a first external device and the individual menu device in the digital color multifunction processing machine 1 of the embodiment of the present invention. Here, with reference to FIG. 9, identifying action of the first external device and the individual menu device is discussed.

The display control part 53d of the individual menu device 53 receives input identification information of the user in step S11.

The display input control part 53d transfers the input identifying information to the common identification control part 53h, and the common identification control part 53h identifies the information following the setting of manager setting information 53n in step S12. Here, in setting the manager setting information 53n, in a case where the item (1) of a management setting table shown in FIG. 7 is “EXTERNAL DEVICE IDENTIFICATION: YES”, the common identification control part 53h requests identification based on the item (2) of the management setting table “PRIORITY IDENTIFICATION SETTING: FIRST=FIRST EXTERNAL DEVICE, SECOND=INDIVIDUAL MENU DEVICE” in step S13.

One of “FIRST EXTERNAL DEVICE”, “SECOND EXTERNAL DEVICE”, and “INDIVIDUAL MENU DEVICE” is set as a first item of priority identification setting. The device which is priority identification set is indicated at the items (3) “FIRST EXTERNAL DEVICE IDENTIFICATION: YES” or (5) “SECOND EXTERNAL DEVICE IDENTIFICATION: YES”.

In addition by setting of “FIRST EXTERNAL DEVICE IDENTIFICATION SETTING: TYPE=WINDOWS (REGISTERED TRADEMARK) SERVER, DOMAIN NAME=YES, IP ADDRESS=YES” of the item (4) or “SECOND EXTERNAL DEVICE IDENTIFICATION SETTING: TYPE=MULTIFUNCTION PROCESSING MACHINE, DOMAIN NAME=NO, IP ADDRESS=NO” of the item (6) of the management table shown in FIG. 7, the connection method of the first and second external devices can be selected. For example, one of the plural server computers (first external devices) provided on the network connected to the digital color multifunction processing machine (individual menu device) can be selectively designated by the domain name or the like.

In a case where the first external device or the second external device is a subject of the first priority identification setting, the individual menu device is selected as a subject of the second priority identification setting. Furthermore, in a case where the individual menu device is the subject of the first priority identification setting, the first external device or the second external device is selected as the subject of the second priority identification setting.

In the case of the item (2) of the management setting table “PRIORITY IDENTIFICATION SETTING: FIRST=FIRST EXTERNAL DEVICE, SECOND=INDIVIDUAL MENU DEVICE”, the common identification control part 53h requests, in step S13, the identification of the first external device from a first external device identification control part 53c by the identification information of the user input in step S11. The first external device identification control part 53c, in step S14, determines the identification with a first external device identification part 51b by an existing protocol. If this identification is not successful (NO in step S14), the identification flow of the user goes back to the beginning.

If the identification is successful (YES of step S14), the common identification control part 53h identifies the individual menu device being set as the second priority identification setting. Hence, the common identification control part 53h requests the identification of the individual menu from the individual menu identification part 53j in step S15. The individual menu identification part 53j determines the identification by the identification information identified (input) by the first external device in step S16. If this identification is not successful (NO in step S16), the identification flow of the user goes back to the beginning. If the identification is successful (YES of step S16), the identification flow is completed so that the individual menu is started in step S17. At this time, since the identification of the first external device identification part 51b is successful, the function of a first external device function implementing part 51a can be used from the individual menu of the individual menu function implementing part 53i. In addition, this identification information is registered in the item (5) “FIRST EXTERNAL DEVICE IDENTIFICATION INFORMATION” of an individual setting table.

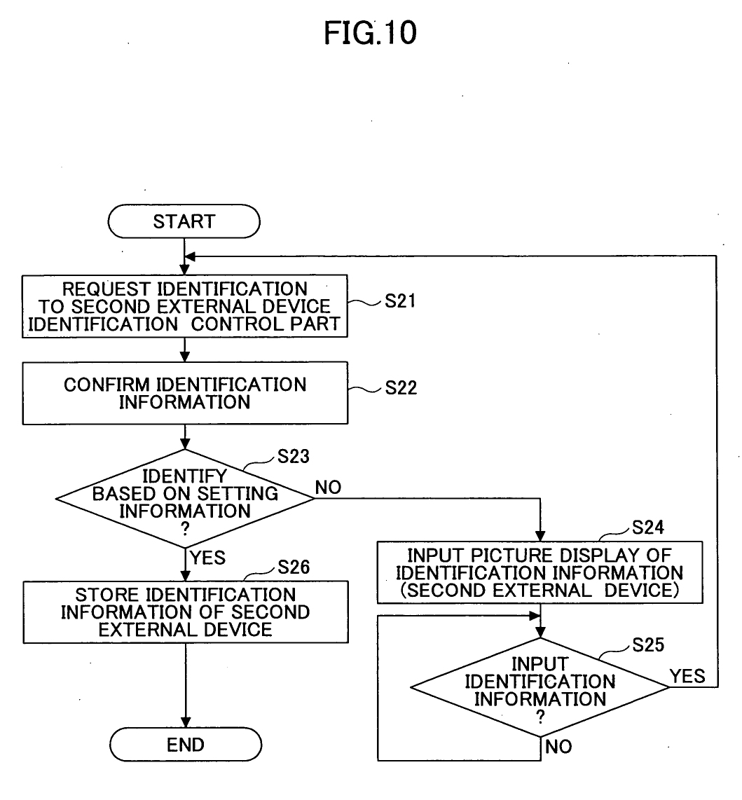

Meanwhile, FIG. 10 is a flowchart showing an operation of additional identifying action of the second external device after the first external device and the individual menu device are identified.

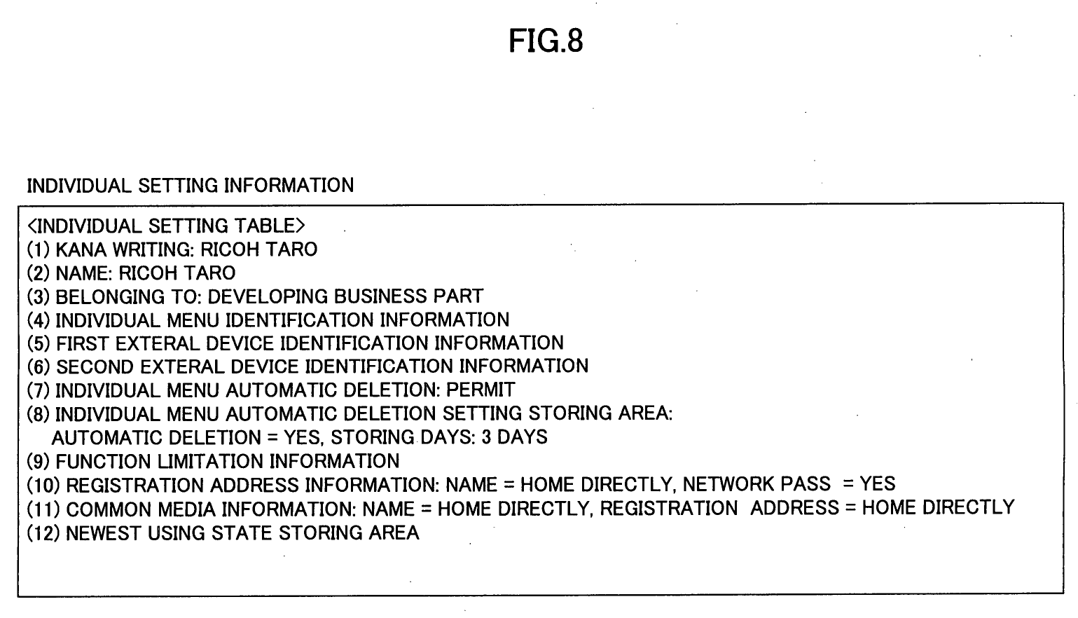

Referring to FIG. 10, at the same time as starting the individual menu or corresponding to the request for using the function of the second external device, the common identification control part 53h requests the identification of the second external device from the second external device identification control part 53g in step S21 so that the second external device identification control part 53g implements identification with a second external device identification part 52f. At this time, the common identification control part 53h confirms so as to obtain “SECOND EXTERAL DEVICE IDENTIFICATION INFORMATION” of the item (6) of the individual setting table shown in FIG. 8 in step S22. This “SECOND EXTERAL DEVICE IDENTIFICATION INFORMATION” of the item (6) of the individual setting table shown in FIG. 8 is the individual setting information 53m of the individual menu identified via the individual menu management part 53k. Here, the existence of registration of the identifying information or whether the information is the input identification information is confirmed.

In step S22, if the identification information is not registered at “SECOND EXTERAL DEVICE IDENTIFICATION INFORMATION” of the item (6) of the individual setting table shown in FIG. 8, since the identifying process with the first external device is already completed, the identification information identified by the first external device is used. If the identification information is registered at “SECOND EXTERAL DEVICE IDENTIFICATION INFORMATION” of the item (6) of the individual setting table shown in FIG. 8, the identification information is obtained and the second external device identification control part 53g implements identification with the second external device identification part 52f in step S23. If this identification is successful (YES in step S23), the individual menu function implementing part 53i can use the function of a second external device function implementing part 52e.

If this identification is not successful (NO in step S23), the common identification control part 53h displays an input dialog on the display input control part 53d again in step S24. This is displayed on a picture as the function of the second external device function implementing part 52e from the individual menu function implementing part 53i. Implementation of the function of the individual menu function implementing part 53i or the first external device function implementing part 51a is not obstructed.

If the user inputs correct identification information to the input dialog (display picture in step S24) (YES in step S25) the common identification control part 53h requests the second external device identification control part 53g to implement the identification with the second external device identification part 52f again in step S21. If the input identification information is confirmed in step S22 and determination of the identification based on this identification information is successful (YES in step S23), the common identification control part 53h stores, via the individual menu management part 53k, correct identification information in “SECOND EXTERAL DEVICE IDENTIFICATION INFORMATION” of the item (6) of the individual setting information 53m shown in FIG. 8 in step S26. This correct identification information is used next time when the second external device identification control part 53g implements the identification with the second external device identification part 52f.

As a result of this, in a case where “SECOND EXTERAL DEVICE IDENTIFICATION INFORMATION” of the item (6) of the individual setting table shown in FIG. 8 is not registered, the identification flow fails only the first time. However, in the identification flow after the second time, the stored information can be used. If the first external device is designated as the subject of the priority identification, the identification flow is completed by only the first external device and the individual menu device. The second external device implements the identification when the function of the second external device function implementing part 52e is used in the individual menu. Because of this, if the user registration of the first external device is identical with user registration of the individual menu, the identification flow is successful. The second external device may identify when the function is required.

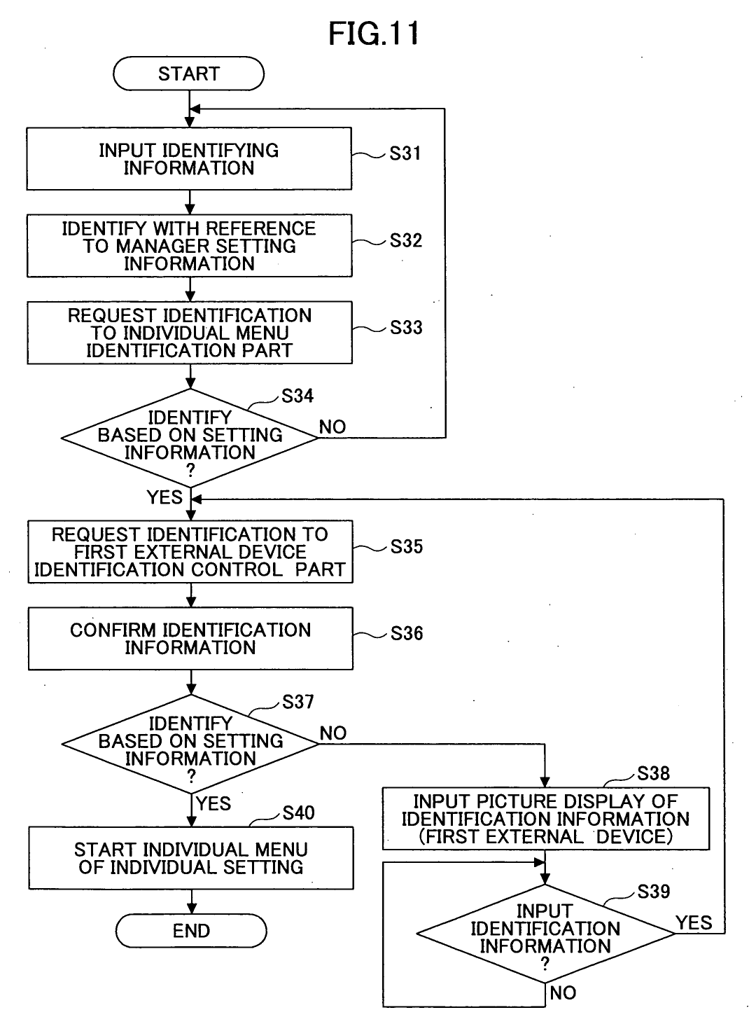

As another identification flow, a case of “PRIORITY IDENTIFICATION SETTING: FIRST=INDIVIDUAL MENU DEVICE, SECOND=FIRST EXTERNAL DEVICE” as the item (2) of the management setting table shown in FIG. 7 is discussed. FIG. 11 shows the identification flow in the case of “PRIORITY IDENTIFICATION SETTING: FIRST=INDIVIDUAL MENU DEVICE, SECOND=FIRST EXTERNAL DEVICE” as the item (2) of the management setting table shown in FIG. 7.

As shown in FIG. 11, a display input control part 53d of the individual menu device 53 receives identifying information of the user from the main picture displayed at the operations panel P, for example in step S31. The identifying information of the user is input from the input picture of the identifying information by pushing the individual identifying key.

The display input control part 53d transfers the input identifying information to the common identification control part 53h. The common identification control part 53h identifies the information following the setting of manager setting information 53n in step S32. Here, since “PRIORITY IDENTIFICATION SETTING: FIRST=INDIVIDUAL MENU DEVICE” as the item (2) of the management setting table shown in FIG. 7 is set, the common identification control part 53h requests identification of the individual menu based on the input identification information from the display input control part 53d from an individual menu identification part 53j in step S33.

Based on this request, the identification is implemented in step S34. If the identification fails (NO in step S34), the identification flow is returned to step S31 so that the user restarts the flow from the beginning. If the identification is successful (YES in step S34) and “PRIORITY IDENTIFICATION SETTING: SECOND=FIRST EXTERNAL DEVICE” as the item (2) of the management setting table shown in FIG. 7 is set, based on the request in step S35, the first external device identification control part 53c implements the identification with the first external device identification part 51b.

At this time, the common identification control part 53h confirms the information, via the individual menu management part 53k, so as to obtain “FIRST EXTERAL DEVICE IDENTIFICATION INFORMATION” of the item (5) of the individual setting table shown in FIG. 8 in step S36.

In step S36, if the identification information is not registered at “FIRST EXTERAL DEVICE IDENTIFICATION INFORMATION” of the item (5) of the individual setting table shown in FIG. 8, the identification information already identified by the individual menu device is used. If the identification information is registered at “FIRST EXTERAL DEVICE IDENTIFICATION INFORMATION” of the item (5) of the individual setting table shown in FIG. 8, the identification information is obtained and the first external device identification control part 53c implements identification with the first external device identification part 51b in step S37.

If this identification is not successful (NO in step S37), the common identification control part 53h displays an input dialog of the identification information on the display input control part 53d again in step S38.

If the user inputs correct identification information to the input dialog (display picture in step S38) (YES in step S39), the common identification control part 53h requests the first external device identification control part 53c to implement the identification with the first external device identification part 51b again in step S35. If the input identification information is confirmed in step S36 and determination of the identification based on this identification information is successful (YES in step S37), the identification flow is completed and the individual menu is started in step S40.

At this time, since the identification of the individual menu identification part 53j is already successful, the function of the first external device function implementing part 51a can be used from the individual menu of the individual menu function implementing part 53i. In addition, the common identification control part 53h stores, via the individual menu management part 53k, correct identification information in “FIRST EXTERAL DEVICE IDENTIFICATION INFORMATION” of the item (5) of the individual setting information 53m shown in FIG. 8. This correct identification information is used next time when the first external device identification control part 53c implements the identification with the first external device identification part 51b.

Since the same explanation as that with reference to FIG. 10 can be applied to a case of the additional identification of the second external device after the individual menu device and the first external device are identified, the explanation is omitted.

If the individual menu device is designated as the first priority of the identification, the identification flow is completed by only the first external device and the individual menu device. The second external device may be identified if necessary. This is the same as the case where the first external device is designated as the first priority of the identification. However, in the case where the individual menu device, unlike the first external device, is designated as the first priority of the identification, identification with the first external device can be implemented by the first and second external device identification information stored in the individual setting table.

In a case where “PRIORITY IDENTIFICATION SETTING: SECOND=SECOND EXTERNAL DEVICE” is set as the item (2) of the management setting table shown in FIG. 7, the same flow as the flow discussed above wherein the “first external device” is switched to “second external device” is applied.

If the first external device is designated as the first priority of the identification, the identification flow is completed by the registered identification information being directly input from the display input control part 53d so that the level of the security can be set high. However, in a case where information of the user name, password, or the like formed by a complicated combination of characters or numbers is input as the identification information at the first external device, a keyboard or the like is necessary as an input part.

If the individual menu device has a keyboard for easily inputting characters such as a computer, there is no problem. However, if the individual menu device is an installing device for a specific object such as a multifunctional processing machine, the individual menu device has no keyboard so that the character inputting is done at the operations panel P shown in FIG. 4.

At the operations panel P, switches where specific functions are allocated are provided close to each other and the picture is small. Hence, there may be input errors when complex character input is made so that experience may be required. It is less practical that such input be implemented every time of the identification. Because of this, if the individual menu device is designated as the subject of the priority identification, identification of only the individual menu is directly input and the stored identification information is used for the first and second external devices so that the identification flow is completed.

For example, if the individual menu devices have only the ten-key, the identification information of the individual menu is necessary every time the identification is made by numbers (for example, an employee number). Input may be required only at the first time and renewal of the password. The identification information of the first and second external devices may be input by the keyboard.

In addition, in the flowcharts shown in FIG. 9 and FIG. 11, the identification with the first external device is implemented based on the input identification information, and the identification flow is completed when the identification is not made. If a line is cut or the electric power of the first external device is turned off so that information is not sent for a while in the first external device connected to the network, the process in step S14 is not implemented but the process goes to step S15 or the process in step S37 is not implemented but the identification flow of the individual menu device is completed so that the individual menu can be started.

As a result of this, even if the identification is not obtained where the network is disconnected for a while, the individual menu can be started. This function can be implemented by setting the item (9) “LOG-IN BY ONLY INDIVIDUAL MENU IDENTIFICATION WHEN EXTERNAL SERVER CONNECTION HAS FAILED: YES” of the management setting table shown in FIG. 7. Even if a network obstacle is generated for a while, by operation of the individual menu, the identification with the second external device is completed and the functions as a single multifunction processing machine can be used without finishing the identification flow of the user who is registered and should be identified.

Next, automatic registration or automatic deletion in the individual menu of another embodiment of the present invention is discussed. At the identification flow of the flowchart shown in FIG. 9, depending on the number of registered users, it takes time and money to register in the individual menu of the individual menu device the same user numbers as in the first external device. In order to avoid this, “AUTOMATIC REGISTRATION IN INDIVIDUAL MENU: YES” of the item (7) of the management setting table is set.

The common identification control part 53h in step S15 of FIG. 9 requests the identification of the individual menu from the individual menu identifying part 53j. The identification requested in step S16 is determined with reference to the individual setting information 53m at the individual menu management part 53k. If the same user is not registered in the individual menu device so that the identification fails, the individual menu of the user is additionally registered so that the identification of the individual menu at the individual menu device is made successfully and the individual menu in step S17 is started.

Because of setting of “AUTOMATIC REGISTRATION IN INDIVIDUAL MENU: YES” of the item (7) of the management setting table, the identification flow is successful by only the identification by the user information registered at the first external device. There is no need to perform user registration at the individual menu device at fist and the individual menu can be started. In the case of the automatic registration, this identification information is stored in the setting of the item (5) “FIRST EXTERAL DEVICE IDENTIFICATION INFORMATION” of the individual setting table.

Similarly, after the individual menu is automatically registered, the identification information stored in the item (6) “SECOND EXTERAL DEVICE IDENTIFICATION INFORMATION” of the individual setting table shown in FIG. 8 for requesting the identification of the second external device is not registered. Hence, the second external device identifying part 52f sets the identification information previously identified as the first device, the identification information of the first external device in this example, as the identification information of the second external device identifying part 52f. As a result of this, at the request of the identification from next second external device identification control part 53g, the same process as the process shown in FIG. 10 is implemented for the second external device and finally the identification flow is completed.

In addition, if the password is changed at the side of the first external device after the user registration is automatically made at the individual menu device, the identification of the individual menu implemented in step S15 and S16 in FIG. 9 fails. In a case of the device connected to the normal network, it is preferable to periodically change the password in order to improve the security level. However, it costs to change the password of the registered individual menu in connection with the first external device. In addition, in the case of the automatic registration, a large number of processes may be required. In order to avoid this situation, the item of (8) “INDIVIDUAL MENU AUTOMATIC DELETION SETTING STORING AREA: AUTOMATIC DELETION=YES” of the management setting table shown in FIG. 7 is set.

As a result of this, the identification fails because, in steps S15 and S16 in FIG. 9, the same user is registered in the individual menu device but the password is different. However, since the identification with the first external device is already finished, the password is renewed so as to be the same as the password of the first external device so that the identification of the individual menu is made successfully and the individual menu in step S5 is started.

By setting the item of (8) “INDIVIDUAL MENU AUTOMATIC DELETION SETTING STORING AREA: AUTOMATIC DELETION=YES”, even if the password is periodically renewed for improving the security level, the corresponding individual menu of the user is connected with this, so that it is not necessary to change the password of the individual menu.

In addition, after the first external device is identified, by setting the “AUTOMATIC REGISTRATION IN INDIVIDUAL MENU: YES” of the item (7) of the management setting table, the individual menu for the user is registered at the first external device and identified by the individual menu device. As a result of this, the number of the identified and registered users is increased. In this case, there may be a limitation to the number of the register-able users and the ability of the device for managing the increased the number of the user may be degraded. Because of this, the registered individual menu is required to be deleted under certain conditions such as the number of days after the last identification is made. For example, when the registered individual menu is identified so that use of the individual menu is started, as the setting of the automatic deletion of the individual menu, the setting of (8) INDIVIDUAL MENU AUTOMATIC DELETION SETTING STORING AREA: AUTOMATIC DELETION=YES, STORING DAYS: 3 DAYS” is registered and renewal is made. A storing period at starting the use of the individual menu is confirmed and compared to the storing period of the item (10) “REGISTRATION ADDRESS INFORMATION: NAME=HOME DIRECTLY, NETWORK PASS=YES” of the management setting table shown in FIG. 7. If the information is different, indication of a warning dialog about setting the automatic deletion is made for the user and then information is renewed.

In the process of the automatic deletion, the user who is the subject of deletion is selected once in a day by a periodic implementation control part 53r and the common identification control part 53h to the individual menu management part 53k so that deletion is implemented. This subject user compares the information of the individual setting table of the individual setting information 53m and the information of the management setting table of the manager setting information 53n.

If the information of the setting condition is the same, the process for deleting is implemented. If the information is different, the process for deletion is not implemented. In addition, even if the information is the same, the process for deletion is implemented after the indication of the warning dialog is implemented for the subject user. If “WARNING INDICATION=NO” is set, at the process once in a day of the periodic implementation control part 53r, deletion is made without warning indication based on the setting of the item (10) of the management table.

Furthermore, the change of the item (7) “INDIVIDUAL MENU AUTOMATIC DELETION: PERMIT” can be made by only the manager but not the user. However, when the setting change by the manager is made, when the individual menu is used the first time after the change, the same condition as the automatic deletion discussed above is made due to the change of the setting so that the warning indication is made.

In addition, as a method for automatic registration for adding the individual menu, when the individual menu is automatically registered with the user identified by the first external device at setting of the item (11) “INITIAL VALUE USER OF INDIVIDUAL REGISTRATION SETTING INFORMATION” of the management setting table, the limitation is given to the function of the device as the initial value user and a model of the individual menu (individual setting table) where only the function permitted by the manager is formed and registered. Based on this model, the individual menu is added by the automatic registration so that the registration is done.

In the individual menu newly added based on this setting, various setting conditions such as preventing use of the facsimile function, preventing use of the facsimile only for an outside line sending number, preventing change of the setting of the address to be sent to are set. In addition, these setting conditions are registered in the item (9) “FUNCTION LIMITATION INFORMATION” of the individual setting table and can be changed later by the manager corresponding to the user.

Furthermore, a single user may be selected, as the initial value user, from users who are currently registered and used or used at the time of new user registration other than the automatic registration. As a result of this, the user setting whose usage degree corresponding to the current usage status is high can be used.

Thus, in the digital color multifunction processing machine of the embodiment of the present invention, the identification is made based on the identification information of the server computer connected to the network. The individual menu starting for using the function of the digital color multifunction processing machine for the user whose identification is completed, is identified. In addition, the registration or deletion of the individual menu is automatically managed.

In the document input and output device for identifying external devices of the embodiment of the present invention, the identification is made based on the identification information of the server computer connected to the network. The individual menu for starting using the function of the digital color multifunction processing machine for the user whose identification is completed, is identified. In addition, the registration or deletion of the individual menu is automatically managed. Furthermore, plural communication protocols are applied and the documents in various data forms are communicated.

The present invention is not limited to these embodiments, but variations and modifications may be made without departing from the scope of the present invention.

This patent application is based on Japanese Priority Patent Application No. 2005-251275 filed on Aug. 31, 2005, the entire contents of which are hereby incorporated by reference.

What is claimed is:

1. A document input and output device for identifying external devices, the document input and output device being connected to a network and using a plurality of communication protocols, the document input and output device communicating documents in various data forms with plural information devices, comprising:
a first identifying part configured to implement an identifying process wherein a function of a first information device can be used by identification of an individual;
a second identifying part configured to implement an identifying process wherein a function of the document input and output device can be used by identification of an individual;
a third identifying part configured to implement an identifying process wherein a function of a second information device can be used by identification of an individual; and
an identification control part configured to control the first through third identifying parts;
wherein the identification control part combines the identifying processes of the first and second identifying parts so as to implement the identifying processes of the first and second identifying parts, and implements the identifying process of the third identifying part at the time when the function of the second information device is used.

2. The document input and output device as claimed in claim 1,
wherein the identifying control part selects the first identifying part or the second identifying part as a priority identifying process.

3. The document input and output device as claimed in claim 1,
wherein if the first information device is identified by the first identifying part using input identifying information, the identifying control part implements the identifying processes for the second information device by using the identification information processed the last time.

4. The document input and output device as claimed in claim 1,
wherein the identification control part implements a next identification process by using identification information previously processed at the identification process of the first identifying part or the second identifying part.

5. The document input and output device as claimed in claim 1,
wherein the identification control part stores identified last identification information at the identification process of the first identifying part or the third identifying part.

6. The document input and output device as claimed in claim 1,
wherein when the identification by the first identifying part is not finished for a while, the identification control part finishes the identification process of the document input and output device by only the identification of the second identifying part.

7. The document input and output device as claimed in claim 6,
wherein the identification control part renews a password used for the identification of the second identifying part following a change of the password used for the identification of the first identifying part.

8. The document input and output device as claimed in claim 1,
wherein the identification control part automatically adds or deletes a registered user identified by the second identifying part based on the identification information identified by the first identifying part.

9. The document input and output device as claimed in claim 8,
wherein the identification control part deletes the registered user identified by the second identifying part if a number of days since a last identification process of the registered user has been implemented exceeds a designated number of days.

10. The document input and output device as claimed in claim 9,
wherein the identification control part does not delete the registered user until a warning is indicated next time when the registered user is identified if the designated number of days for deleting the registered user is changed.

11. The document input and output device as claimed in claim 8,
wherein the identification control part selects setting of a process for automatically adding or deleting the registered user identified by the second identifying part.

12. The document input and output device as claimed in claim 8,
wherein the identification control part performing a function of the document input and output device is registered in advance as an initial value user for a setting being automatically added and used for the registered user identified by the second identifying part.

13. A document input and output device for identifying external devices, the document input and output device being connected to a network and using a plurality of communication protocols, the document input and output device communicating documents in various data forms with a plurality of information devices, comprising:
first means for implementing an identifying process wherein a function of a first information device can be used by identification of an individual;
second means for implementing an identifying process wherein a function of the document input and output device can be used by identification of an individual;
third means for implementing an identifying process wherein a function of a second information device can be used by identification of an individual; and
means for controlling the first through third means;
wherein the means for controlling the first through third means combines the identifying processes of the first and second means so as to implement the identifying processes of the first and second means, and implements the identifying process of the third means at the time when the function of the second information device is used.

14. An identifying processing method of a document input and output device, comprising:
a first step of implementing an identifying process wherein a function of a first information device can be used by identification of an individual;
a second step of implementing an identifying process wherein a function of the document input and output device can be used by identification of an individual; and
a third step of implementing an identifying process wherein a function of a second information device can be used by identification of an individual;
wherein the identifying processes of the first and second steps are implemented by combining the identifying processes of the first and second steps; and
the identifying process of the third step is implemented at the time when the function of the second information device is used.

15. The identifying processing method of the document input and output device as claimed in claim 14,
wherein the first step identifying process or the second step identifying process is selected as a priority identifying process.

16. The identifying processing method of the document input and output device as claimed in claim 14,
wherein if the first information device is identified by the first step identifying process using input identifying information, the identifying process for the second information device is implemented by using the identification information processed the last time.

17. The identifying processing method of the document input and output device as claimed in claim 14,
wherein a next identification process is implemented by using the identification information previously processed at the identification process of the first step or the second step.

18. The identifying processing method of the document input and output device as claimed in claim 14,
wherein last identification information is stored at the identification process of the first step or the third step.

19. The identifying processing method of the document input and output device as claimed in claim 14,
wherein when the identification by the first step identifying process is not finished for a while, the identification process of the document input and output device is finished by only the identification of the second step identifying process.

20. The identifying processing method of the document input and output device as claimed in claim 19,
wherein a password used for the identification of the second step identifying process is renewed following a change of the password used for the identification of the first step identifying process.
